(19) United States
(12) Patent Application Publication
(10) Pub. No.: US 2013/0066665 A1
(43) Pub. Date: Mar. 14, 2013

(54) SYSTEM AND METHOD FOR AUTOMATED SELECTION OF WORKFLOWS

(71) Applicants: Deepali TAMHANE, San Bruno, CA (US); John D. BERKLEY, San Bruno, CA (US); Antonio CASACUBERTA, San Bruno, CA (US)

(72) Inventors: Deepali TAMHANE, San Bruno, CA (US); John D. BERKLEY, San Bruno, CA (US); Antonio CASACUBERTA, San Bruno, CA (US)

(21) Appl. No.: 13/229,610

(22) Filed: Sep. 9, 2011

(51) Int. Cl. G06Q 10/00; G06Q 30/00

(52) U.S. Cl. 705/7.12

(57) ABSTRACT

A method for selecting a business process workflow. The method includes the steps of receiving a set of performance results, where each performance result is associated with a different business process workflow executed by a business process engine, determining a best-performing business process workflow based on selecting the business process workflow having the highest performance result in the set of performance results, and automatically routing work items through the selected business process workflow.

### BACKGROUND

1. Field of the Invention

The present invention relates to the field of business process management, and, in particular, to a system and method for automated selection of workflows.

2. Description of the Related Art

A business process management (BPM) engine, or workflow engine, can be used to design and implement business execution actions, such as marketing campaigns, compensation calculation models, and supply chain management models. In the marketing campaign example, a marketer can use the BPM engine to configure a series of connected workflow execution components that make up a marketing campaign. Some BPM engines allow the marketer to visually design, manage, and automate a multi-stage lifecycle marketing campaign through a drag-and-drop user interface and a library of pre-built campaign templates.

Marketers desire to optimize or improve the effectiveness of their marketing campaigns. One popular method for doing so is known as “A/B” testing, which involves comparing the response rate to a baseline marketing communication sent to a baseline control group of customers to the response rates to a variety of single-variation alternate marketing communications sent to other groups of customers statistically similar to the baseline control group in order to determine the marketing communication variation yielding the highest customer response rate. In particular, an employer of the NB testing method might distribute multiple variations of a marketing communication, each differing from the baseline communication with respect to a single content element such as copy text, layout, images and/or colors, to see which single variable is most effective in increasing customer response rates. By continuously tweaking and testing elements of a marketing communication's content, marketers can often yield significant improvements in customer response.

However, the effectiveness of traditional A/B testing has been limited in assessing the effectiveness of complex multi-stage marketing campaigns involving a series of alternative marketing communications and multiple decision branches. In addition, in recent years, the number of channels through which marketing campaign content may be delivered to customers has undergone a significant increase. For example, e-mail marketing, online banners, short message service (SMS) advertising, and smartphone application banners are now being heavily used by marketers. As a result, it has become exceedingly difficult to optimize a multi-stage cross-channel marketing campaign by testing the effectiveness of variations in such campaign, as such variations can include not just changes in marketing communication content but also variations in the timing, sequence and number of communications as well as variations in the marketing channel used to deliver each communication.

Accordingly, there remains a need in the art for a technique that addresses the drawbacks and limitations discussed above with respect to testing the effectiveness of a marketing campaign.

### SUMMARY

One embodiment of the invention provides a method for selecting a business process workflow. The method includes the steps of receiving a set of performance results, where each performance result is associated with a different business process workflow executed by a business process engine, determining a best-performing business process workflow based on selecting the business process workflow having the highest performance result in the set of performance results, and automatically routing work items through the selected business process workflow.

Another embodiment of the invention provides a system for selecting a business process workflow. The system includes a processor configured to perform the steps of receiving a set of performance results, where each performance result is associated with a different business process workflow executed by a business process engine, determining a best-performing business process workflow based on selecting the business process workflow having the highest performance result in the set of performance results, and automatically routing work items through the selected business process workflow.

Further embodiments of the present invention provide a non-transitory computer-readable storage medium that includes instructions for causing a computer system to carry out one or more of the methods set forth above.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a networked computer environment in which embodiments of the invention may be practiced.

FIG. 2A is a conceptual diagram of an auto-selecting business process that implements a hold-out audience, according to one embodiment of the invention.

FIG. 2B is a conceptual diagram of a state transition diagram between states included within a stage of the business process workflow, according to one embodiment of the invention.

FIG. 3 is a conceptual diagram of an auto-selecting business process that implements multiple channels, according to one embodiment of the invention.

FIG. 4 is a conceptual diagram of an auto-selecting business process that implements timing variations, according to one embodiment of the invention.

FIG. 5 is a conceptual diagram of a workflow selector configuration interface that enables an administrator to automatically or manually select a best-performing workflow, according to one embodiment of the invention.

FIG. 6 is a flow diagram of method steps for automating the selection of a workflow, according to one embodiment of the invention.

### DETAILED DESCRIPTION OF EXEMPLARY EMBODIMENTS

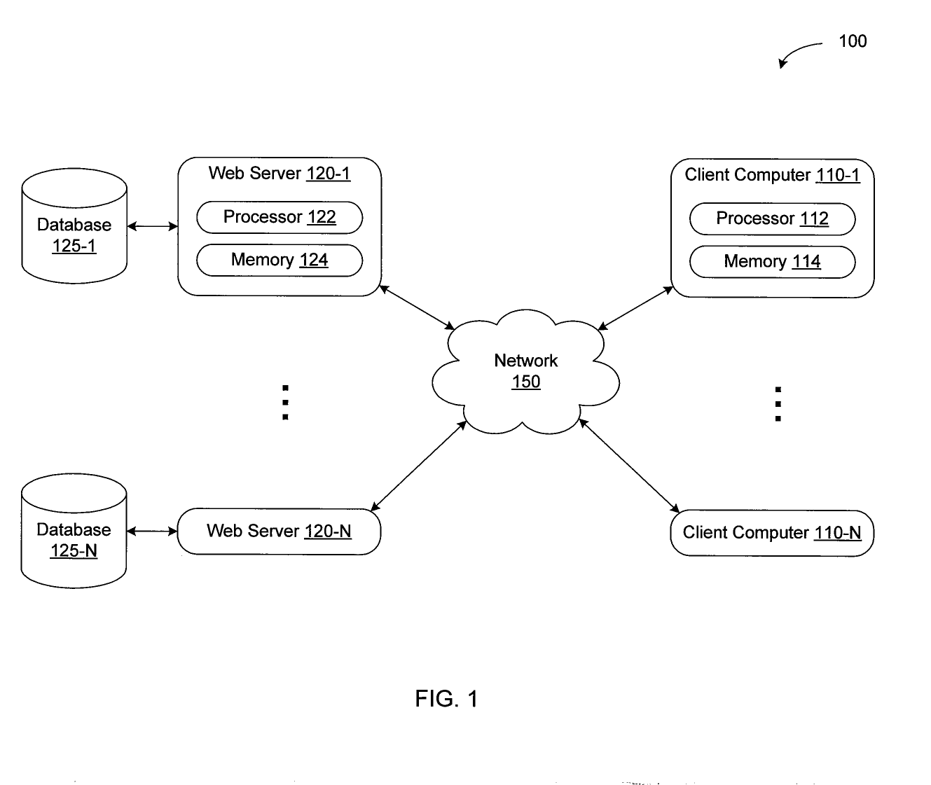

FIG. 1 illustrates a networked computer environment 100 in which embodiments of the invention may be practiced. As shown, networked computer environment 100 includes a plurality of client computers 110 (only two of which are shown) and a plurality of web servers 120 with associated databases 125. Client computers 110 and web servers 120 are connected over a computer network 150, e.g., the Internet.

Each client computer 110 includes conventional components of a computing device, e.g., a processor 112, a system memory 114, a hard disk drive, input devices such as a mouse and a keyboard, and output devices such as a monitor, among others. Each web server 120 includes a processor 122 and a system memory 124, and manages the contents stored in respective database 125 using, for example, a relational database. The web server 120 is programmed to communicate with client computers 110 and other web servers 120 using, e.g., the TCP/IP protocol. Client computers 110 are programmed to execute web browser programs and other software applications and access the web pages and/or applications managed by the web servers by specifying a uniform resource locator (URL) for the web server into the browser.

In the embodiments of the present invention described below, users are respectively operating client computers 110 that are connected to web servers 120 over the Internet. The web pages that are displayed to a user are transmitted from web servers 120 to that user's client computer 110 and processed by the web browser program stored in that user's client computer 110 for display through the monitor of that user's client computer 110.

Client computer 110 may be a personal computer, smart phone, touch pad, touch screen, or any other device suitable for practicing one or more embodiments of the present invention. It should be noted that the present invention can be implemented in hardware, software, or in a combination of hardware and software, e.g., using application specific integrated circuits (ASIC), a general purpose computer or any other hardware equivalents.

In one embodiment, a BPM engine is stored in memory 114 of a client computer 110 and is executed by processor 112 included therein. In other embodiments, the BPM engine is stored in memory 124 of a web server 120 and is executed by processor 122 included therein. The web server 120 may be configured to deliver a user interface to the user at the client computer 110 via the network 150. For example, the user interface may be displayed in a web browser executed by the client computer 110.

### Efficient Workflow Execution

Embodiments of the invention provide a technique for automatically selecting a best-performing workflow. In particular, a graphical user interface for designing and implementing workflows is provided, and the underlying system provides mechanisms for identifying the best-performing workflow and routing subsequent workflow content through the best-performing workflow.

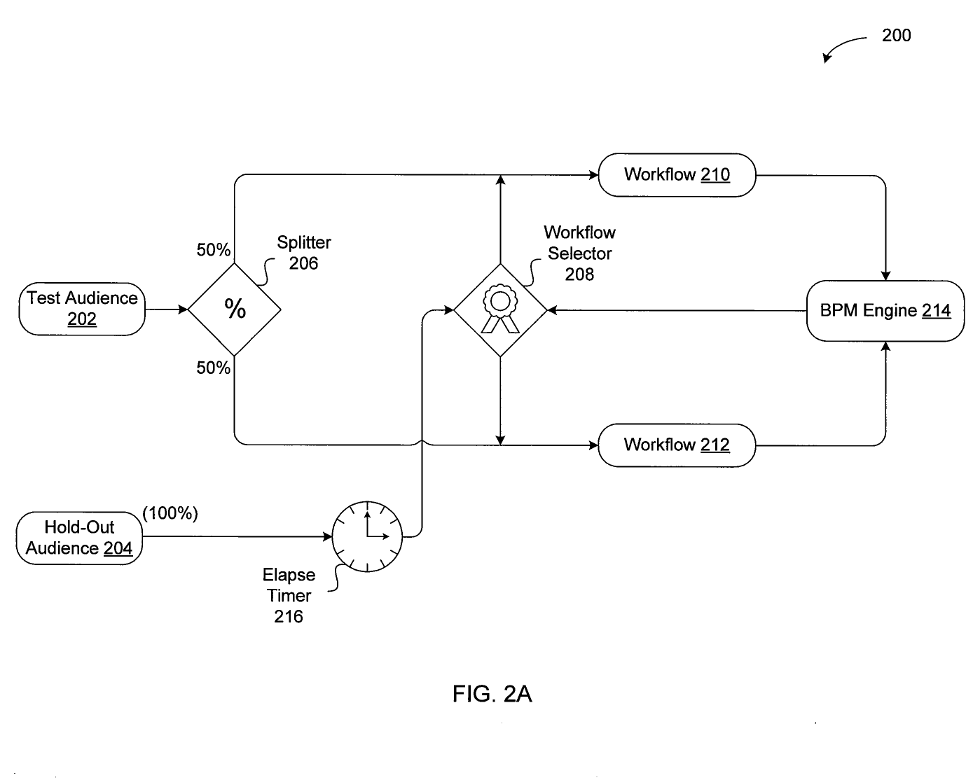

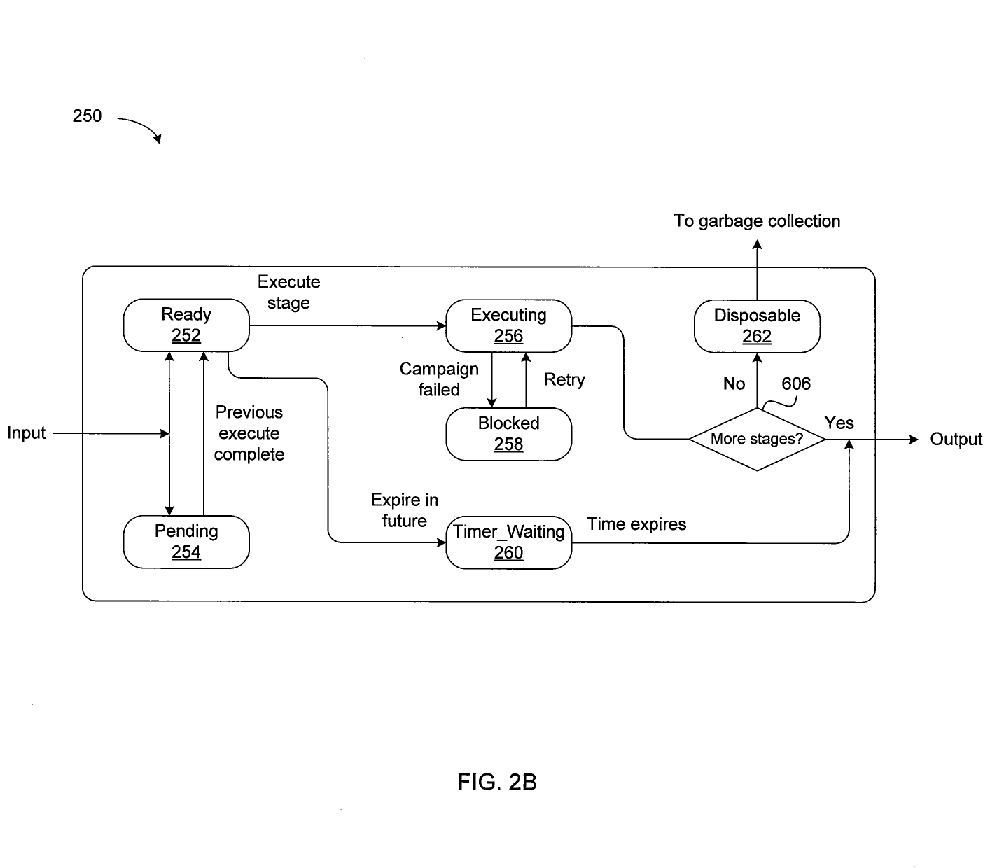

FIG. 2A is a conceptual diagram of an auto-selecting business process 200 that implements a hold-out audience, according to one embodiment of the invention. In one embodiment, a BPM engine 214 allows a user to visually design, manage, and automate a business process through a drag-and-drop user interface and a library of pre-built program templates. For example, FIG. 2A illustrates a marketing campaign designed by a marketer.

As shown, a test audience 202 is fed into a splitter 206, which routes half of test audience 202 into workflow 210 and the other half of test audience 202 into workflow 212. Alternatively, splitter 206 may be configured to split a portion of audience 202 in a random or designated manner. For example, splitter 206 may select at random ten percent of the individuals included in test audience 202 and route half of these individuals into workflow 210 and the other half of these individuals into workflow 212. In another example, a different number of individuals can be routed by the splitter 206 to workflow 210 than is routed to workflow 212. In yet another example, splitter 206 may avoid selecting individuals who have been identified by BPM engine 214 through previous business processes, e.g., repeat-customers, until the best-performing workflow is identified by BPM 214, described in detail below.

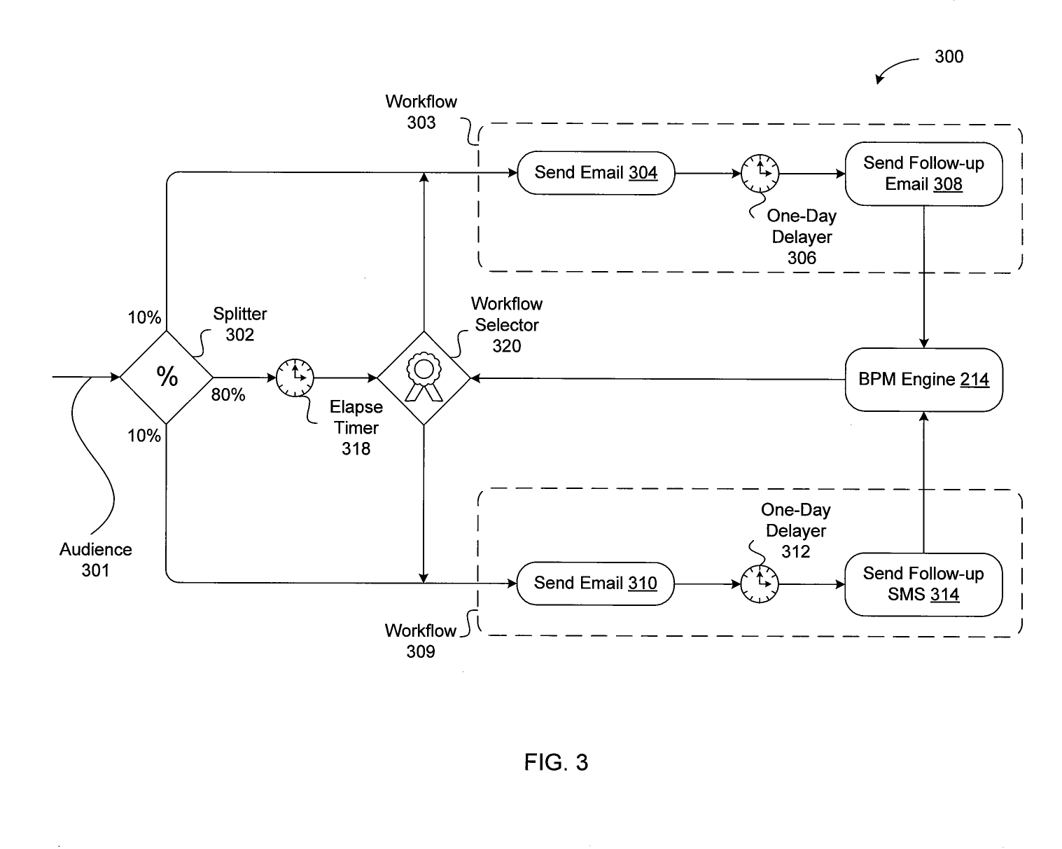

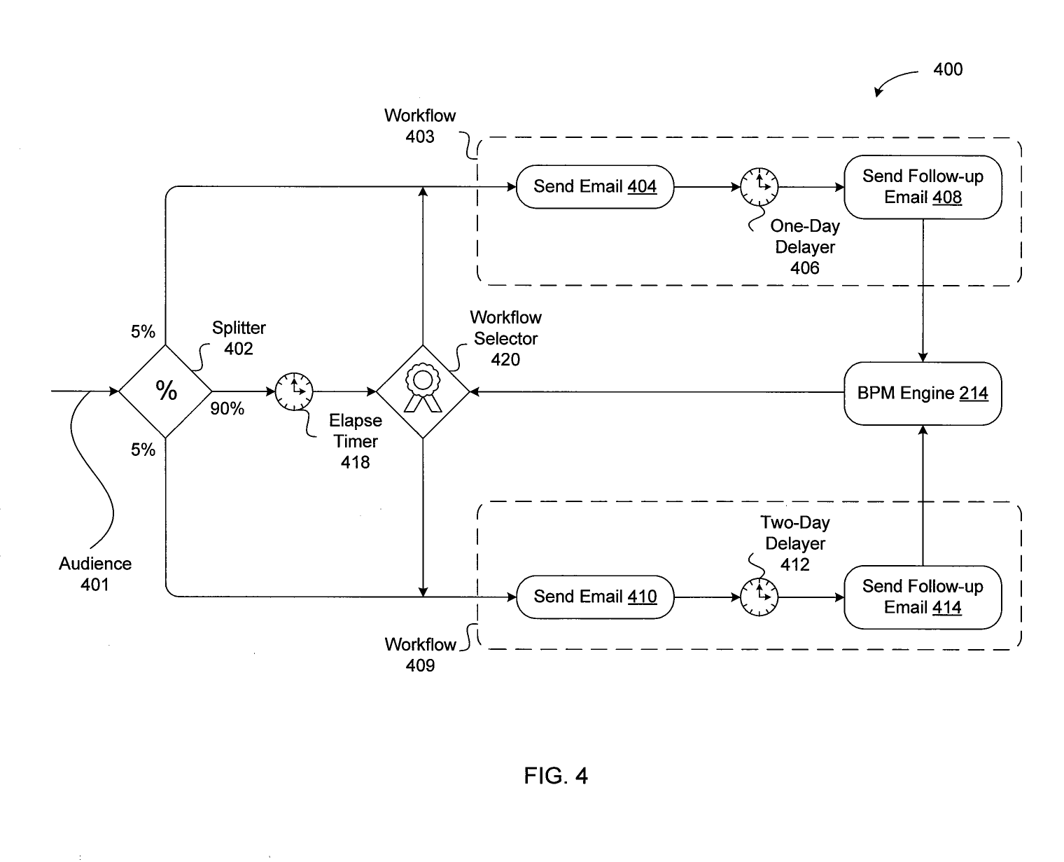

Workflow 210 and workflow 212 represent two separate and distinct workflows that are configured to provide different approaches to delivering content to the portion of test audience 202, described in detail below in conjunction with FIGS. 3-4. For example, workflow 210 and workflow 212 may each include a “welcome campaign” stage. In one embodiment, a stage is an abstract class that represents a component within the business process workflow. Examples of stages include an email campaign stage, an SMS (short message service) campaign stage, an elapsed timer stage, a gateway (or “switch”) stage, or any other technically feasible type of stage. In some embodiments, different business logic may be associated with each of the different types of stages.

In one example of a welcome campaign stage, each work item (i.e., each user) in the group receives a welcome email. The number of work items may be quite large, i.e., on the order of millions or billions of work items. In some embodiments, an optimized technique for sending mass emails may be used in conjunction with embodiments of the invention in order to efficiently deliver emails to a large number of recipients. Various techniques are known in the art for sending mass emails.

In some embodiments, each stage may include multiple “states” within the stage connected by a state transition diagram. FIG. 2B is a conceptual diagram of a state transition diagram between states included within a stage of a business process, according to one embodiment of the invention.

As shown in FIG. 2B, a group of work items is input into a stage 250. In the embodiment shown, the stage 250 includes a ready state 252, a pending state 254, an executing state 256, a blocked state 258, a timer waiting state 260, and a disposable state 262.

At the ready state 252, the group of work items is ready for execution of the stage 250. When a group of work items is initially created and the stage 250 is the first stage of the business process workflow, the group is in ready state 252. When an entire group of work items moves from a previous stage to current stage together, the group is in ready state 252.

At the pending state 254, the stage 250 is buffering membership and is not ready for execution. For example, assume that the previous stage was an SMS campaign stage. In an SMS campaign stage, SMS messages are sent synchronously one at a time to each recipient in the group. As SMS messages are sent, the recipients that receive a successful transmission are moved to the pending state 254 of the next stage 250. Once the previous stage has completed executing (e.g., all of the recipients in the previous stage have received a successful SMS transmission), the state of the group transitions to the ready state 252, described above.

At the executing state 256, the stage 250 is executing on the group of work items. For example, in an email campaign stage, the executing state 256 is associated with sending emails to each recipient in the group, and in an SMS campaign stage, the executing state 256 is associated with sending SMS messages to each recipient in the group.

At the blocked state 258, the group of work items has failed execution, i.e., an error has occurred. Some embodiments of the invention provide technical support to cure the error and/or the ability to manually re-launch or retry a failed campaign.

After the executing state 256 is complete, if additional stages exist in the business process workflow, then the group state transitions to the “ready state” for the next stage of the business process workflow. If no additional stages exist, then the group state transitions to the disposable state 262. A group of work items becomes disposable when the stage 250 is the last stage of the business process workflow or when there are no subsequent stages. A garbage collection process can be scheduled to perform garbage collection at a low load time and can delete the group membership and group for this stage 250.

The timer waiting state 260 is associated with a stage 250 that is an “elapsed time” stage having a future expiration date. For example, the stage 250 may be associated with a timer that causes a wait time of 30 days to pass before proceeding to the next stage of the business process workflow. When the expiration time has passed, the group state transitions to the “ready state” for the next stage of the business process workflow.

Although the stage 250 described in FIG. 2B is shown having particular states and state transitions, many other implementations of the stage are also within the scope of embodiments of the invention. For example, the stage can include different states, different transitions between states, or can be implemented in any technically feasible manner, which may not include states.

Referring back now to FIG. 2A, BPM engine 214 is configured to monitor the performance of both workflow 210 and workflow 212. For example, if workflow 210 includes a welcome campaign stage that is implemented using e-mail messages, then BPM engine 214 might monitor hyperlinks included in the e-mail messages to determine whether recipients thereof click the hyperlink(s). In another example, if workflow 212 includes a “welcome campaign” stage that is implemented using SMS messages, then BPM engine 214 might monitor received SMS messages to determine which of the recipients respond to the message that they receive. In this way, BPM engine 214 may effectively determine the greater customer response rate between workflow 210 and workflow 212.

When BPM engine 214 makes the foregoing determination, a workflow selector 208, under the control of BPM engine 214, automatically routes hold-out audience 204 to the winning workflow, as illustrated in FIG. 2. Moreover, BPM engine 214 may monitor elapse timer 216, which designates when hold-out audience 204 is to be routed through workflow selector 208. For example, if elapse timer 216 is configured to enact a three-day delay, BPM engine 214 would monitor the performances of workflow 210 and workflow 212 for three-days, and, when the three-days have passed, BPM engine 214 would configure workflow selector 208 to route hold-out audience 204 to the best-performing workflow.

In addition to the foregoing, BPM engine 214 may instead be configured to notify an administrator when the time period associated with elapse timer 216 is met. In this way, the administrator may perform additional analyses before choosing to manually route hold-out audience 204 through the winning workflow.

FIG. 3 is a conceptual diagram of an auto-selecting business process 300 that implements multiple channels, according to one embodiment of the invention. As shown, an audience 301 is routed into a splitter 302, which routes 10% of audience 301 through workflow 303 and 10% of audience 301 through workflow 309.

Workflow 303 includes three stages: send email 304, one-day delayer 306, and send follow-up email 308. Similarly, workflow 309 begins with the stages send email 310 and one-day delayer 312; however, instead of incorporating a send follow-up email stage as the final stage, workflow 309 incorporates send follow-up SMS 314. In this way, BPM engine 214, which is configured to monitor workflow 303 and workflow 309, may determine whether audience 310 has a better rate of response to email follow-ups vs. SMS follow-ups. Accordingly, when a time value is associated with elapse timer 318, e.g., five days, is satisfied, BPM engine 214 routes the additional 80% of audience 301 through the best-performing workflow, i.e., workflow 303 or workflow 309.

FIG. 4 is a conceptual diagram of an auto-selecting business process 400 that implements timing variations, according to one embodiment of the invention. As shown, an audience 401 is routed into a splitter 402, which routes 5% of audience 401 through workflow 403 and 5% of audience 401 through workflow 409.

Here, workflow 403 includes three stages: send email 404, one-day delayer 406, and send follow-up email 408. Similarly, workflow 409 begins with send email 410 and ends with send follow-up email 414; however, instead of incorporating a one-day delay as an intermediate stage between send email 410 and send follow-up email 414, workflow 409 incorporates a two-day delayer 412. In this way, BPM engine 214, which is configured to monitor workflow 403 and workflow 409, may effectively determine whether audience 410 has a better rate of response to reminders sent one day after an initial email or reminders sent two days after an initial email. Accordingly, when a time value is associated with elapse timer 418, e.g., three days, is met, analysis engine routes 214 the additional 90% of audience 401 through workflow selector 420, and inherently, through the winning workflow, i.e., workflow 403 or workflow 409.

As is described in further detail below, workflow selectors may be configured via a user interface hosted by BPM engine 214.

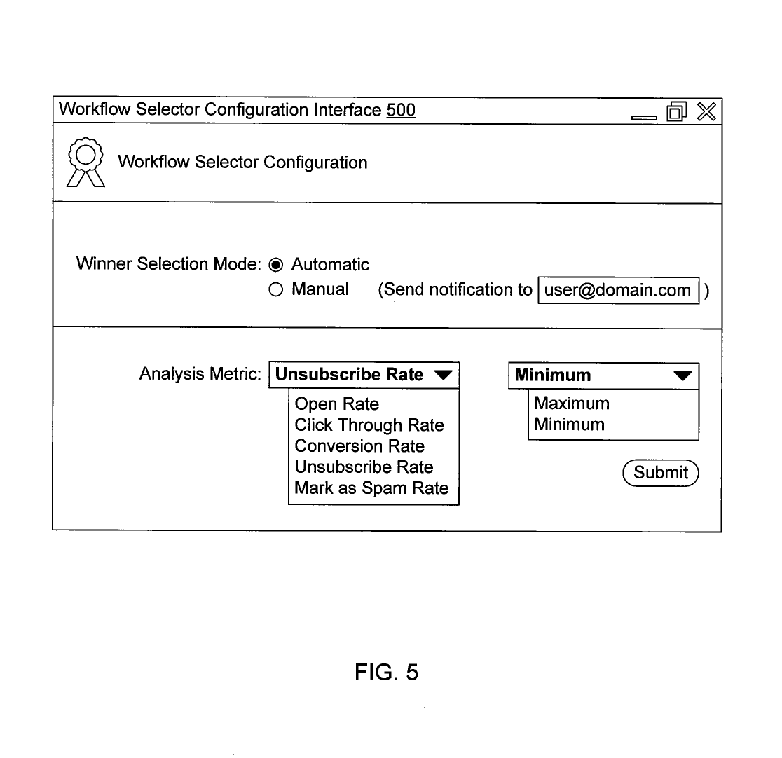

FIG. 5 is a conceptual diagram of a workflow selector configuration interface that enables an administrator to automatically or manually select a best-performing workflow, according to one embodiment of the invention. As shown, workflow selector configuration interface 500 enables an administrator to specify a winner selection mode and an analysis metric. As described herein, if an administrator sets the winner selection mode for a workflow selector as “automatic,” then BPM engine 214 automatically configures the workflow selector to route all traffic to the winning workflow when, for example, a threshold amount of time has elapsed.

The administrator is additionally able to specify an analysis metric by which the workflow selector identifies, under the control of BPM engine 214, the winning workflow. For example, workflow selector 420 in FIG. 4 may select workflow 403 as the winning workflow if the emails sent in workflow 403 (i.e., via send email 404 and send follow-up email 408) receive a fewer number of unsubscribe requests than the emails sent in workflow 409. In another example, workflow selector 320 in FIG. 3 may select workflow 309 as the winning workflow if the emails and/or follow-up SMS messages sent in workflow 309 result in a higher conversion rate than the emails sent in workflow 303.

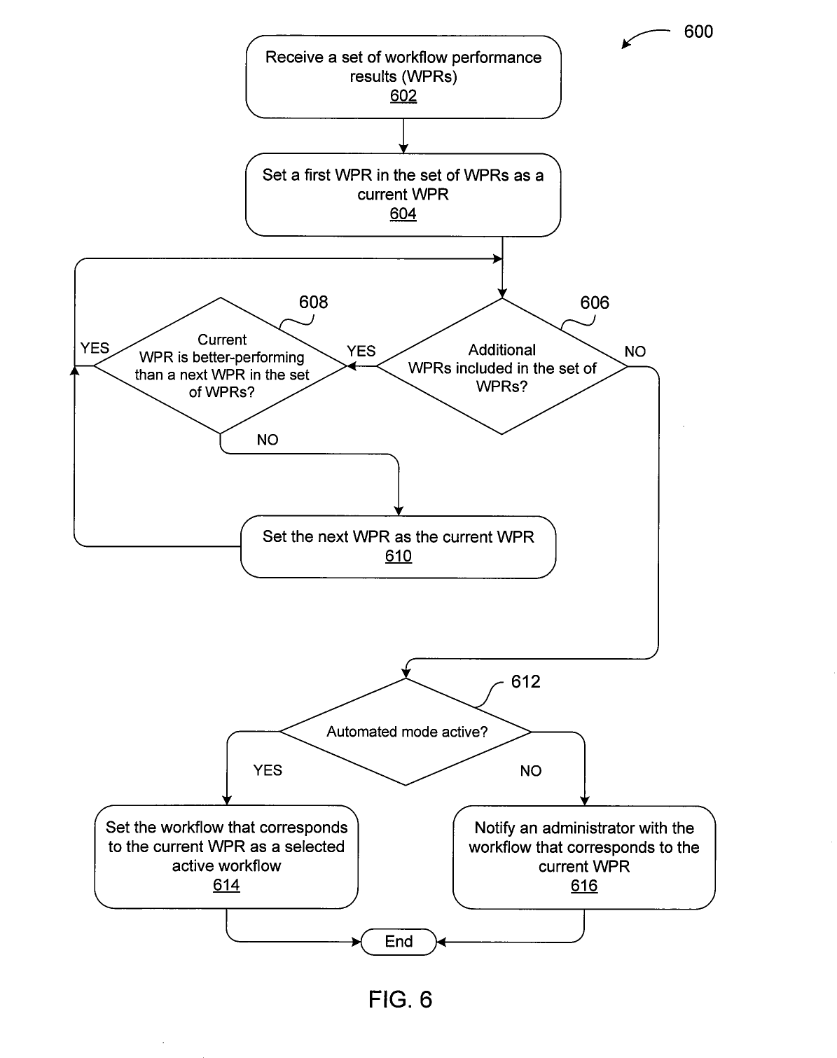

FIG. 6 is a flow diagram of a method 600 for automating the selection of a workflow, according to one embodiment of the invention. Persons skilled in the art will understand that, even though the method 600 is described in conjunction with FIGS. 1-5, any system configured to perform the method steps is within the scope of embodiments of the invention.

At step 602, BPM engine 214 receives a set of workflow performance results (WPRs) that are calculated by BPM engine 214 according to the techniques described above in conjunction with FIGS. 2A-4. At step 604, BPM engine 214 sets a first WPR in the set of WPRs as a current WPR. At step 606, BPM engine 214 determines whether additional WPRs are included in the set of WPRs. In this way, BPM engine 214 parses each WPR included in the set of WPRs to determine which of the WPRs is the best-performing WPR. If, at step 606, BPM engine 214 determines that additional WPRs are included in the set of WPRs, then method 600 proceeds to step 608.

At step 608, BPM engine 214 determines whether the current WPR is better-performing than a next WPR in the set of WPRs. Again, BPM engine 214 may make this determination according to a variety of techniques, e.g., according to the analysis metrics described above in conjunction with FIG. 5. If, at step 608, BPM engine 214 determines that the current WPR is better-performing than a next WPR in the set of WPRs, then method 600 proceeds to step 610. Otherwise, method 600 proceeds back to step 606 described above, where the current WPR remains the same.

At step 610, BPM engine 214 sets the next WPR as the current WPR, and method 600 proceeds back to step 606, which is described above. The method steps 606-610 are repeated until BPM engine 214 compares each WPR in the set of WPRs to determine which of the WPRs is the best-performing WPR.

Referring back now to step 606, if BPM engine 214 determines that no additional WPRs are included in the set of WPRs, then method 600 proceeds to step 612, where BPM engine 214 determines whether an automated mode or a manual mode is active, as described above in conjunction with FIG. 5. If, at step 612, BPM engine 214 determines that an automated mode is active, then method 600 proceeds to step 614, where BPM engine 214 sets the workflow that corresponds to the current WPR as a selected active workflow, as described herein. Otherwise, method 600 proceeds to step 616, where BPM engine 214 notifies an administrator with the workflow that corresponds to the current WPR.

In sum, embodiments of the invention provide a technique for evaluating and automatically selecting a best-performing workflow. As a result, marketers are able to test the customer response to not only content-based variations in marketing communications, such as copy, layout, images, and/or text, but also variations in timing, sequence, frequency, and/or delivery channel.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

1. A computer implemented method for selecting a business process workflow, the method comprising:
receiving a performance metric for each of a plurality of different business process workflows, executed by a business process engine;
selecting the business process workflow that has the highest performance metric as a best-performing business process workflow; and
automatically routing work items through the best-performing business process workflow,
wherein each business process workflow is associated with a different marketing campaign that targets individuals associated with the work items.

2. The method of claim 1, wherein the best-performing business process workflow is selected after a threshold amount of time has passed.

3. (canceled)

4. The method of claim 1, wherein the performance metric for the business process workflow is based on at least one of an open rate, a click-through rate, a conversion rate, and an unsubscribe rate.

5. The method of claim 1, wherein the targeted individuals comprise individuals that do not receive any marketing campaign content until the best-performing business process workflow is selected.

6. The method of claim 1, wherein the targeted individuals receive marketing campaign content at different intervals.

7. The method of claim 1, wherein the targeted individuals receive each marketing campaign content through different channels.

8. The method of claim 1, wherein the targeted individuals receive different marketing campaign content.

9. (canceled)

10. A non-transitory computer-readable medium storing instructions that, when executed by a processor, cause a computer system to select a business process workflow, by performing the steps of:
receiving a performance metric for each of a plurality of different business process workflows executed by a business process engine;
selecting the business process workflow that has the highest performance metric as a best-performing business process workflow; and
automatically routing work items through the best-performing business process workflow,
wherein each business process workflow is associated with a different marketing campaign that targets individuals associated with the work items.

11. The non-transitory computer-readable medium of claim 10, wherein the best-performing business process workflow is selected after a threshold amount of time has passed.

12. (canceled)

13. The non-transitory computer-readable medium of claim 10, wherein the performance metric for the business process workflow is based on at least one of an open rate, a click-through rate, a conversion rate, and an unsubscribe rate.

14. The non-transitory computer-readable medium of claim 10, wherein the targeted individuals comprise individuals that do not receive any marketing campaign content until the best-performing business process workflow is selected.

15. The non-transitory computer-readable medium of claim 10, wherein the targeted individuals receive marketing campaign content at different intervals.

16. The non-transitory computer-readable medium of claim 10, wherein the targeted individuals receive marketing campaign content through different channels.

17. The non-transitory computer-readable medium of claim 10, wherein the targeted individuals receive different marketing campaign content.

18. (canceled)

19. A computer system, comprising:
a processor configured to evaluate and automatically select a business process workflow, by performing the steps of:
receiving a set of performance metric for each of a plurality of different business process workflows, executed by a business process engine;
selecting the business process workflow that has the highest performance metric as a best-performing business process workflow; and
automatically routing work items through the best-performing business process workflow,
wherein each business process workflow is associated with a different marketing campaign that targets individuals associated with the work items.

20. (canceled)
